(19) United States
(12) Patent Application Publication
(10) Pub. No.: US 2025/0103104 A1
(43) Pub. Date: Mar. 27, 2025

(54) EXPANDED SCREEN

(71) Applicant: Junxuan CAO, Xinyi City, Guangdong Province (CN)

(72) Inventor: Junxuan CAO, Xinyi City, Guangdong Province (CN)

(21) Appl. No.: 18/495,619

(22) Filed: Oct. 26, 2023

(30) Foreign Application Priority Data
Sep. 27, 2023 (CN) 202322647553.3

(51) Int. Cl. G06F 1/16

(52) U.S. Cl. CPC G06F 1/166; G06F 1/1626

(57) ABSTRACT

The present disclosure provides an expanded screen. The expanded screen includes a display device and a support capable of being configured to support the display device on a platform. The support is rotatably arranged on a back surface of the display device. One surface of the support is rotated to abut against the back surface of the display device. The other surface of the support is also rotated to abut against the back surface of the display device. One surface of a support can be rotated to abut against a back surface of the display device, and the other surface of the support can also be rotated to abut against the back surface of the display device, so that the support can be located at any angle in the rotating process. A user can watch a display device in multiple angles, and the user experience is improved.

### CROSS-REFERENCE TO RELATED APPLICATIONS

The application claims priority of Chinese patent application CN202322647553.3, filed on Sep. 27, 2023, which is incorporated herein by reference in its entireties.

### TECHNICAL FIELD

The present disclosure relates to an expanded screen, applied to the technical field of terminal devices.

### BACKGROUND

In the prior art, terminals have become essential items in life. With the increasing demand of people, expanded-screen terminals have been born. Sizes of screens of traditional terminal products, such as laptops and desktop displays, have already been determined in a production process, but in practical applications, it is difficult to meet needs of customers for multiple screens or a large screen. Therefore, in order to meet the needs of the consumers, a split screen display technology is usually used to achieve a multi-screen display effect.

However, when an existing expanded screen is placed on a platform, and a supporting angle of a support arranged on a display device is adjusted relative to the display device, an adjustment angle is limited, resulting in a limited viewing angle for a user to adjust the display device. A single viewing angle makes the user experience poor. In addition, the functions of the existing expanded screen are all configured on the display device, so that many spare parts need to be arranged inside the display device. As a result, the display device has a large overall thickness.

### SUMMARY

In response to the following problem of the expanded screen in the prior art: a supporting angle of a support arranged on a display device is adjusted relative to the display device, an adjustment angle is limited, resulting in a limited viewing angle for a user to adjust the display device, and a single viewing angle makes the user experience poor, the present disclosure provides an expanded screen. One surface of a support can be rotated to abut against a back surface of the display device, and the other surface of the support can also be rotated to abut against the back surface of the display device, so that the support can be located at any angle in the rotating process. In this way, multi-angle adjustment of the support can be achieved. A user can watch a display device in multiple angles, and the user experience is improved.

The technical solution adopted by the present disclosure to solve the technical problem is as follows:

An expanded screen, wherein the expanded screen includes a display device and a support capable of being configured to support the display device on a platform; the support is rotatably arranged on a back surface of the display device; one surface of the support is rotated to abut against the back surface of the display device; and the other surface of the support is also rotated to abut against the back surface of the display device.

Further, the support divides the back surface of the display device into a left abutting surface and a right abutting surface; one surface of the support is able to abut against one abutting surface of the back surface of the display device; and the other surface of the support is able to abut against the other abutting surface of the back surface of the display device.

Further, when one surface of the support abuts against one abutting surface of the back surface of the display device, a fourth side surface of the support is arranged close to a bottom surface of the display device.

Further, the expanded screen further includes a rotating assembly; the rotating assembly is connected to the display device and the support; and the support is in damped rotation with the display device through the rotating assembly.

Further, the expanded screen further includes a gasket; the gasket is arranged on a first side surface of the support; and the rotating assembly is arranged on the gasket to form a space between the rotating assembly and the display device.

Further, the expanded screen further includes more than one interface; each interface is arranged on the support; and the interface is electrically connected to the display device through a wire.

Further, a first side surface of the support is provided with a first threading hole; the back surface of the display device is provided with a second threading hole; the second threading hole is located below the first side surface of the support; and the wire passes through the second threading hole and the first threading hole in the display device and is connected to each interface.

Further, one end of the first side surface of the support is provided with a gap; a wiring slot is arranged on the back surface of the display device corresponding to a position below the gap; the wiring slot is provided with a shell covering the wiring slot, and the shell is arranged in the gap; the second threading hole is arranged in the wiring slot; the first threading hole is arranged on a side surface of the gap; the shell is provided with a third threading hole; the wire passes through the second threading hole, the third threading hole, and the first threading hole; and a part of the wire is arranged in the wiring slot.

Further, the first threading hole is arranged at a joint of two adjacent side surfaces of the gap, and the third threading hole is arranged on an end surface of the shell close to the first threading hole.

Further, a top surface of the shell is set to be an outwards convex arc; a groove is arranged on one surface of the gap rotating around the top surface of the shell; and a top of the top surface of the shell is arranged in the groove.

Further, the support is provided with a holding port.

Further, the holding port is provided with an opening; and the opening is arranged on the first side surface of the support.

Further, the holding port is T-shaped.

Further, each interface is arranged on an inner side wall of the holding port.

Further, a second side surface of the support and a third side surface of the support are arranged on two adjacent sides of the first side surface of the support; a width from the second side surface of the support to the third side surface of the support is a width of the support; the width of the support is less than a width of the display device; and a width central axis of the support is arranged close to a width central axis of the display device.

Further, a first antiskid pad is arranged on a fourth side surface of the support opposite to the first side surface of the support.

Further, a bottom surface of the display device is provided with more than one second antiskid pad.

Further, a hand groove is arranged on a fourth side surface of the support.

Further, the hand groove is close to a middle position of the fourth side surface of the support along a length.

Further, the expanded screen further includes an audio port, an expanded screen on/off button, and a volume adjustment button; and the audio port, the expanded screen on/off button, and the volume adjustment button are arranged on the support.

Beneficial effects of the present disclosure are as follows: The present disclosure provides an expanded screen. The gasket is arranged between the rotating assembly and the display device. The gasket jacks up the rotating assembly, so that the space is caused between the rotating assembly and the display device. The rotating assembly can drive one surface of the support to rotate to abut against the back surface of the display device, and the other surface of the support can also be rotated to abut against the back surface of the display device. The rotating assembly is in damped rotation. In the rotating process, the support can be located at any angle. In this way, multi-angle adjustment of the support can be achieved, a user can watch the display device in multiple angles, and the user experience is improved. The interfaces, the audio port, the expanded screen on/off button, and the volume adjustment button are all arranged on the support, so that the display device can be thinned, and has a more attractive appearance. The threading hole is correspondingly arranged on the first side surface of the support, so that the wire will not be pulled back and forth in the rotating process of the support, and the life of the wire is prolonged.

### BRIEF DESCRIPTION OF THE DRAWINGS

FIG. 1 is a three-dimensional diagram of an expanded screen according to the present disclosure;

FIG. 2 is an exploded diagram of an expanded screen according to the present disclosure;

FIG. 3 is a diagram of a usage state of an expanded screen according to the present disclosure;

FIG. 4 is a diagram of a rotating state of an expanded screen according to the present disclosure;

FIG. 5 is an enlarged view of A according to the present disclosure;

FIG. 6 is an exploded diagram of an expanded screen according to the present disclosure;

FIG. 7 is an enlarged view of B according to the present disclosure;

FIG. 8 is a diagram of a rotating state of an expanded screen according to the present disclosure; and

FIG. 9 is a diagram of a usage state of an expanded screen according to the present disclosure.

### DETAILED DESCRIPTION OF THE EMBODIMENTS

In order to make the aims, technical solution and advantages of the present disclosure will be clearly, the present disclosure is further described below in combination with accompanying drawings and implementations. It should be understood that the specific embodiments described herein are intended only to explain the present disclosure and are not intended to define the present disclosure.

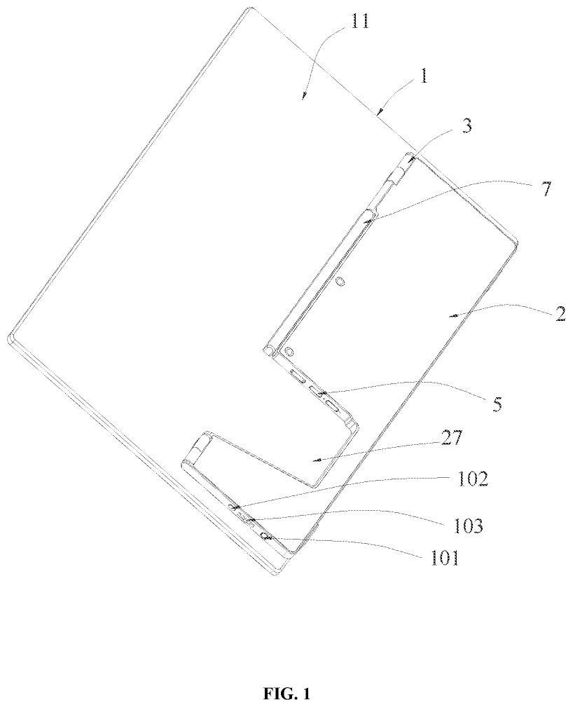

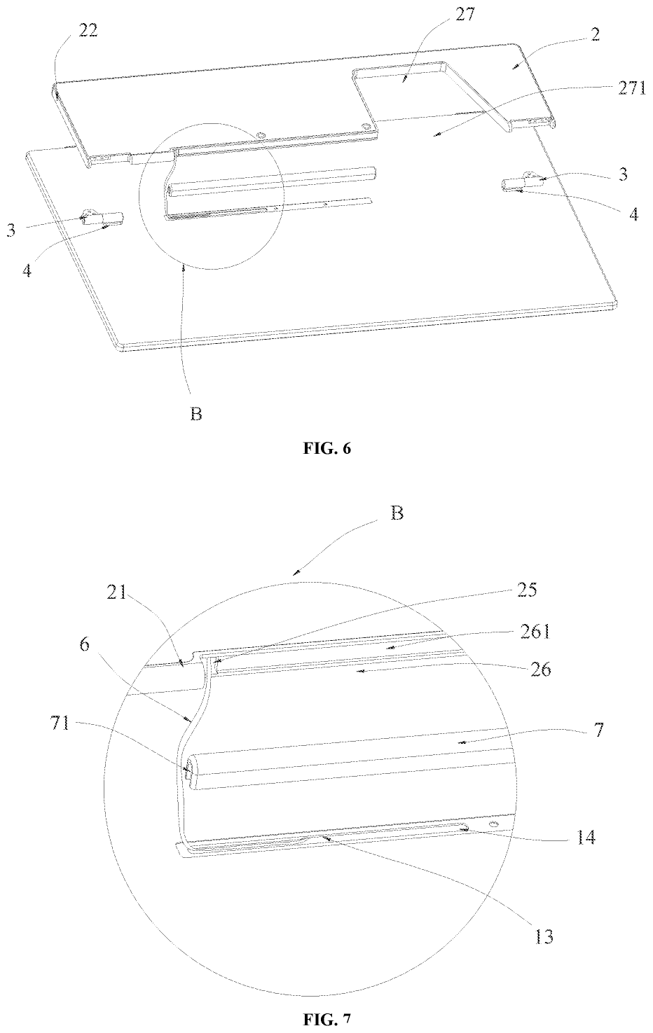

Referring to FIG. 1 to FIG. 9, the present disclosure provides an expanded screen. The expanded screen can transmit information to a display in a plugged, wired, and/or wireless manner. The composition of the display device of the expanded screen can be a structure of a well-known display device, and will not be limited here. As shown in FIG. 1 to FIG. 3, the expanded screen includes a display device 1 and a support 2 that can be configured to support the display device 1 on a platform. The support 2 is rotatably arranged on a back surface 11 of the display device. One surface of the support 2 can be rotated to abut against the back surface 11 of the display device, and the other surface of the support 2 can also be rotated to abut against the back surface 11 of the display device. As a whole, one surface of the support can be rotated to abut against the back surface of the display device, and the other surface of the support can also be rotated to abut against the back surface of the display device, so that the support can be located at any angle in the rotating process. In this way, multi-angle adjustment of the support can be achieved. A user can watch a display device in multiple angles, and the user experience is improved.

In this embodiment, as shown in FIG. 1 to FIG. 3, the support 2 divides the back surface 11 of the display device into a left abutting surface and a right abutting surface; one surface of the support 2 can abut against one abutting surface of the back surface 11 of the display device; and the other surface of the support 2 can abut against the other abutting surface of the back surface 11 of the display device. It can be understood that if the back surface 11 of the display device is flat, the support 2 can be adjusted by rotation 180°, making it convenient for a user to adjust an angle of watching the display device at will. According to the support of the existing expanded screen, one end of a rotating shaft presses against the display device after the support is rotated to a certain angle, and the support cannot be rotated anymore, so that an adjustment angle is limited. Compared with the support of the existing expanded screen, the support in this embodiment can be rotated in a maximum range to abut against the display device, which is more convenient for a user to use.

In this embodiment, when one surface of the support 2 abuts against the back surface 11 of the display device, a fourth side surface 24 of the support 2 is arranged close to a bottom surface 12 of the display device 1. It can be understood that the bottom surface of the support is arranged as close as possible to the bottom surface of the display device, so that the support can be rotated from a minimum supporting angle to a maximum supporting angle. That is, if the back surface 11 of the display device is flat, the supporting angle can be 0° to 180°, and the expanded screen can be used in multiple angles. If the bottom surface of the support is far away from the bottom surface of the display device, and if the back surface 11 of the display device is flat, the supporting angle cannot be adjusted between 0° and 180°, but within a range of 0° to 180°. Some supporting angles are eliminated. Therefore, it is preferable to arrange the bottom surface of the support as close as possible to the bottom surface of the display device.

In this embodiment, as shown in FIG. 1 to FIG. 3, the expanded screen further includes a rotating assembly 3. The rotating assembly 3 is connected to the display device 1 and the support 2, and the support 2 is in damped rotation with the display device 1 through the rotating assembly 3. The damped rotation in this embodiment is an existing technology on the market, which can be liquid damping, gas damping, or friction damping. According to the liquid damping, the rotating assembly usually contains liquid, such as oil or a liquid polymer. According to the gas damping, gas is used, such as a gas spring or a gas closed chamber. When a rotating component moves, the gas will be compressed and expanded in a damper to generate resistance and reduce the rotating speed. In this embodiment, the liquid damping is preferred, which is cheaper and safer. A value of the resistance of damping can be adjusted according to the understanding of a manufacturer on the comfort of a user, but it should be ensured that the value of the resistance can support the display device. The damped rotation makes the rotating process smoother and controlled, thus reducing noise and vibration generated by the movement and prolonging the life of equipment. The smooth movement and the reduction of the vibration can reduce wear and damage of the equipment, and prolong the service life of the equipment.

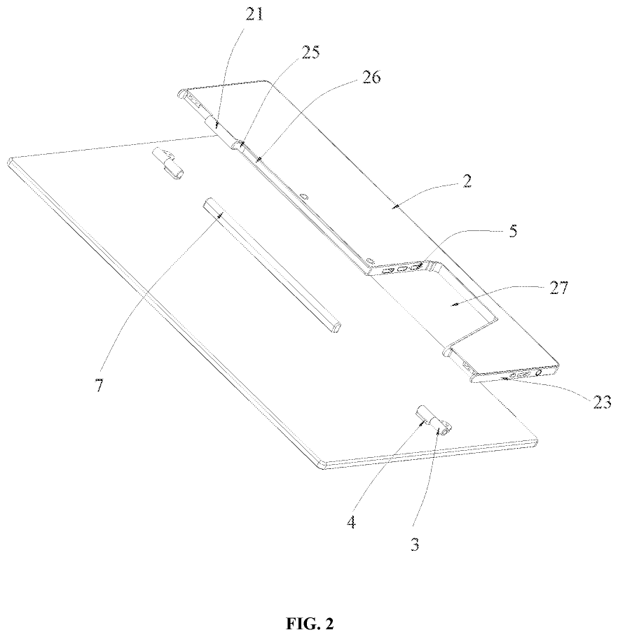

In this embodiment, as shown in FIG. 2 to FIG. 6, the expanded screen further includes a gasket 4. The gasket 4 is arranged on a first side surface 21 of the support 2, and the rotating assembly 3 is arranged on the gasket 4 to form a space 201 between the rotating assembly 3 and the display device 1. The space 201 is as shown in FIG. 5, which means that the first side surface 21 of the support can be regarded as a rotating end, and the gasket 4 jacks up the rotating assembly. The rotating assembly is connected to the rotating end of the support. In this way, the support 2 can divide the back surface 11 of the display device into a left abutting surface and a right abutting surface. One surface of the support 2 can abut against one abutting surface of the back surface 11 of the display device, and the other surface of the support 2 can abut against the other abutting surface of the back surface 11 of the display device.

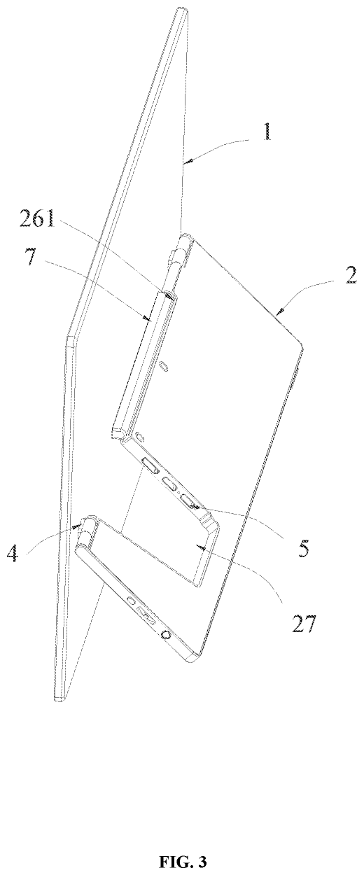

In this embodiment, as shown in FIG. 2 to FIG. 3, the expanded screen also includes more than one interface 5. Each interface 5 is arranged on the support 2. The interface 5 is electrically connected to the display device 1 through a wire 6. The interface is connected to a terminal through a data cable, so that an image can be projected onto the display device of the expanded screen. The interfaces can be, but are not limited to, a DP interface, a DVI interface, a MicroUSB interface, and VGA. The interfaces can be arranged on the support according to a need of a user. This can reduce the arrangement of internal spare parts of the display device and reduce wiring arrangement, so that a display screen is thinner and more attractive in appearance.

The above rotating assembly includes a fixed member and a rotating member. The rotating member can be arranged on the fixed member in a damped rotation manner. The fixed member is fixedly arranged on the gasket. The rotating member is fixedly connected to the support. The support is driven to rotate by the rotating member. The gasket jacks up both the fixed member and the rotating member, so as to mainly enable the rotating member to rotate to a maximum extent.

In this embodiment, as shown in FIG. 7, a first side surface 21 of the support is provided with a first threading hole 25; the back surface of the display device 1 is provided with a second threading hole 13; the second threading hole 13 is located below the first side surface 21 of the support; and the wire 6 passes through the second threading hole 13 and the first threading hole 25 in the display device 1 and is connected to each interface 5. It can be understood that the second threading hole 13 is arranged below the first side surface 21 of the support. In this way, when the support is rotated, the wire will not be pulled with the rotation of the support, which prevents the wire from being pulled to damage other spare parts, also reduces friction of the wire, and protects the life of the wire.

In this embodiment, as shown in FIG. 2, one end of the first side surface 21 of the support is provided with a gap 26; a wiring slot 14 is arranged on the back surface 11 of the display device corresponding to a position below the gap 26; the wiring slot 14 is provided with a shell 7 covering the wiring slot 14, and the shell 7 is arranged in the gap 26; the second threading hole 13 is arranged in the wiring slot 14; the first threading hole 25 is arranged on a side surface of the gap 26; the shell 7 is provided with a third threading hole 71; the wire 6 passes through the second threading hole 13, the third threading hole 71, and the first threading hole 25; and a part of the wire 6 is arranged in the wiring slot 14. It can be understood that the wire is better protected, and the whole design of the expanded screen is more attractive. Furthermore, the wire can be set to be relatively long and is arranged in the wiring slot. In this way, when the support slightly drives the wire to be pulled during rotation, the wire inside the display device or the wire inside the support will not be pulled.

In this embodiment, as shown in FIG. 7, the first threading hole 25 is arranged at a joint of two adjacent side surfaces of the gap 26, and the third threading hole 71 is arranged on an end surface of the shell close to the first threading hole 25. The wire is better hidden, and the appearance is more attractive.

In this embodiment, as shown in FIG. 2 to FIG. 3, a top surface of the shell 7 is set to be an outwards convex arc; a groove 261 is arranged on one surface of the gap 26 rotating around the top surface of the shell 7; and a top of the top surface of the shell 7 is arranged in the groove 261. More wires can be accommodated, and the appearance is more attractive.

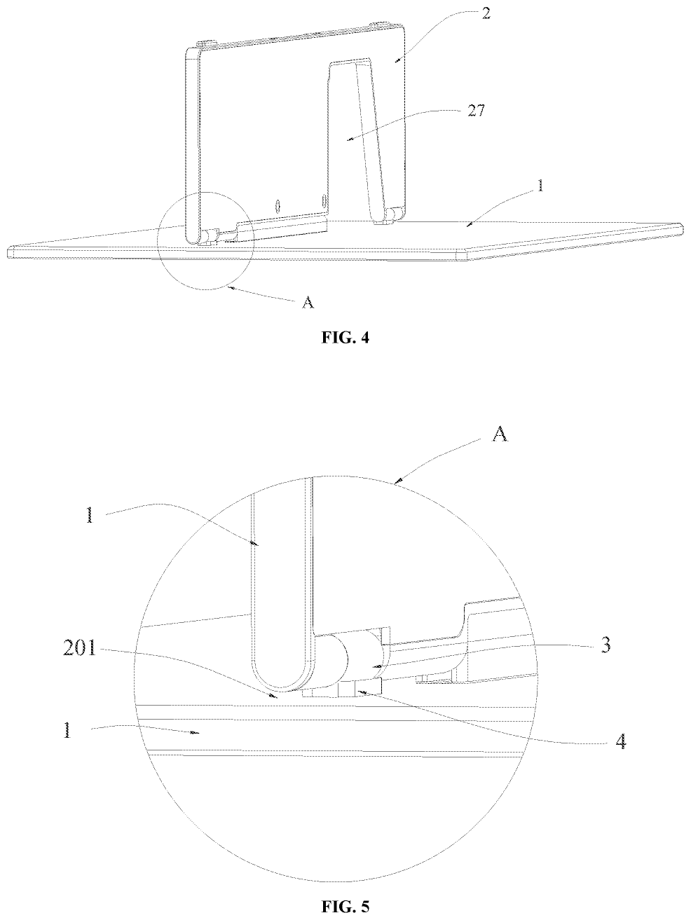

In this embodiment, as shown in FIG. 4 to FIG. 6, the support 2 is provided with a holding port 27, which is convenient for a user to take up and put down the expanded screen.

In this embodiment, as shown in FIG. 4 to FIG. 6, the holding port 27 is provided with an opening 271; and the opening 271 is arranged on the first side surface 21 of the support, so that the expanded screen is more attractive in appearance and is more convenient to hold. Demolding of the support is facilitated, and a mold is convenient to make. The interfaces 5 are arranged on an inner side wall of the holding port 27, so that the interfaces can be hidden, and the expanded screen looks tidier.

In this embodiment, as shown in FIG. 4 to FIG. 6, the holding port 27 is T-shaped, which is more attractive.

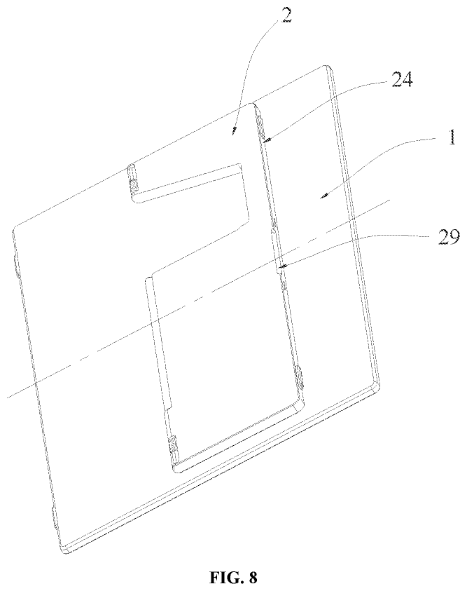

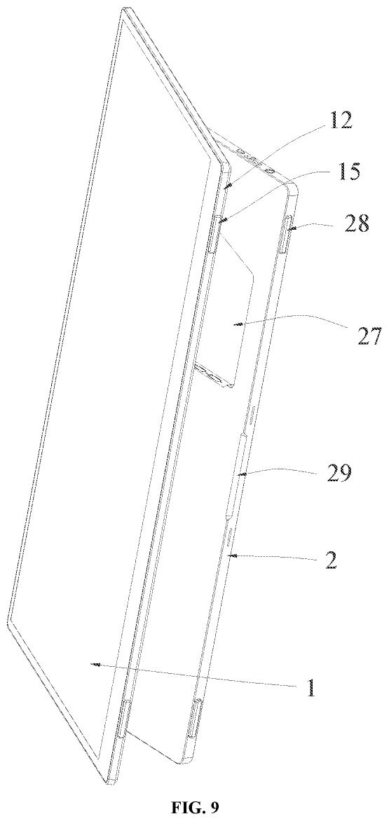

In this embodiment, as shown in FIG. 8 to FIG. 9, a second side surface 22 of the support 2 and a third side surface 23 of the support 2 are arranged on two adjacent sides of the first side surface 21 of the support; a width from the second side surface 22 of the support to the third side surface 23 of the support is a width of the support 2; the width of the support 2 is less than a width of the display device 1; and a width central axis of the support 2 is arranged close to a width central axis of the display device 1. The central axis is the dotted line as shown in FIG. 8. That is, there is a certain distance from the second side surface 22 of the support and the third side surface 23 of the support to two side surfaces of two ends of the display device. In this way, the expanded screen can stand upright, referring to the diagram of standing of the expanded screen shown in FIG. 9.

In this embodiment, as shown in FIG. 9, a first antiskid pad 28 is arranged on a fourth side surface 24 of the support opposite to the first side surface 21 of the support, so as to achieve an antiskid effect.

In this embodiment, a bottom surface 12 of the display device is provided with more than one second antiskid pad 15, as shown in FIG. 9, so as to achieve an antiskid effect.

In this embodiment, as shown in FIG. 8 to FIG. 9, a hand groove 29 is arranged on a fourth side surface 24 of the support. If no hand groove is arranged, when a surface of the support abuts against the display device, it is inconvenient for a user to take up the support. The handle groove is more convenient for the user to use the support.

In this embodiment, as shown in FIG. 8 to FIG. 9, the hand groove 29 is close to a middle position of the fourth side surface 24 of the support along a length.

In this embodiment, as shown in FIG. 1, the expanded screen further includes an audio port 101, an expanded screen on/off button 102, and a volume adjustment button 103; and the audio port 101, the expanded screen on/off button 102, and the volume adjustment button 103 are arranged on the support 2.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. An expanded screen, wherein the expanded screen comprises a display device and a support capable of being configured to support the display device on a platform; the support is rotatably arranged on a back surface of the display device; one surface of the support is rotated to abut against the back surface of the display device; and the other surface of the support is also rotated to abut against the back surface of the display device.

2. The expanded screen according to claim 1, wherein the support divides the back surface of the display device into a left abutting surface and a right abutting surface; one surface of the support is able to abut against one abutting surface of the back surface of the display device; and the other surface of the support is able to abut against the other abutting surface of the back surface of the display device.

3. The expanded screen according to claim 2, wherein when one surface of the support abuts against one abutting surface of the back surface of the display device, a fourth side surface of the support is arranged close to a bottom surface of the display device.

4. The expanded screen according to claim 1, wherein the expanded screen further comprises a rotating assembly; the rotating assembly is connected to the display device and the support; and the support is in damped rotation with the display device through the rotating assembly.

5. The expanded screen according to claim 4, wherein the expanded screen further comprises a gasket; the gasket is arranged on a first side surface of the support; and the rotating assembly is arranged on the gasket to form a space between the rotating assembly and the display device.

6. The expanded screen according to claim 1, wherein the expanded screen further comprises more than one interface; each interface is arranged on the support; and the interface is electrically connected to the display device through a wire.

7. The expanded screen according to claim 6, wherein a first side surface of the support is provided with a first threading hole; the back surface of the display device is provided with a second threading hole; the second threading hole is located below the first side surface of the support; and the wire passes through the second threading hole and the first threading hole in the display device and is connected to each interface.

8. The expanded screen according to claim 7, wherein one end of the first side surface of the support is provided with a gap; a wiring slot is arranged on the back surface of the display device corresponding to a position below the gap; the wiring slot is provided with a shell covering the wiring slot, and the shell is arranged in the gap; the second threading hole is arranged in the wiring slot; the first threading hole is arranged on a side surface of the gap; the shell is provided with a third threading hole; the wire passes through the second threading hole, the third threading hole, and the first threading hole; and a part of the wire is arranged in the wiring slot.

9. The expanded screen according to claim 8, wherein the first threading hole is arranged at a joint of two adjacent side surfaces of the gap, and the third threading hole is arranged on an end surface of the shell close to the first threading hole.

10. The expanded screen according to claim 9, wherein a top surface of the shell is set to be an outwards convex arc; a groove is arranged on one surface of the gap rotating around the top surface of the shell; and a top of the top surface of the shell is arranged in the groove.

11. The expanded screen according to claim 6, wherein the support is provided with a holding port.

12. The expanded screen according to claim 11, wherein the holding port is provided with an opening; and the opening is arranged on the first side surface of the support.

13. The expanded screen according to claim 12, wherein the holding port is T-shaped.

14. The expanded screen according to claim 11, wherein each interface is arranged on an inner side wall of the holding port.

15. The expanded screen according to claim 1, wherein a second side surface of the support and a third side surface of the support are arranged on two adjacent sides of the first side surface of the support; a width from the second side surface of the support to the third side surface of the support is a width of the support; the width of the support is less than a width of the display device; and a width central axis of the support is arranged close to a width central axis of the display device.

16. The expanded screen according to claim 1, wherein a first antiskid pad is arranged on a fourth side surface of the support opposite to the first side surface of the support.

17. The expanded screen according to claim 1, wherein a bottom surface of the display device is provided with more than one second antiskid pad.

18. The expanded screen according to claim 1, wherein a hand groove is arranged on a fourth side surface of the support.

19. The expanded screen according to claim 18, wherein the hand groove is close to a middle position of the fourth side surface of the support along a length.

20. The expanded screen according to claim 1, wherein the expanded screen further comprises an audio port, an expanded screen on/off button, and a volume adjustment button; and the audio port, the expanded screen on/off button, and the volume adjustment button are arranged on the support.
